(19) United States
(12) Patent Application Publication
(10) Pub. No.: US 2021/0237258 A1
(43) Pub. Date: Aug. 5, 2021

(54) LOAD TRANSFER BELT ADAPTED TO CARRY AT LEAST ONE ACCESSORY OF A PASSIVE EXOSKELETON

(71) Applicant: ERGOSANTE TECHNOLOGIE, Anduze (FR)

(72) Inventors: Fabien TOURNEUX, Anduze (FR); Martin JOUET-PASTRE, Anduze (FR); Pol LE BORGNE, Anduze (FR); Kévin LEBEL, Anduze (FR)

(21) Appl. No.: 17/049,187

(22) PCT Filed: Apr. 26, 2019
(86) PCT No.: PCT/FR2019/000062

§ 371 Date: Oct. 20, 2020

(30) Foreign Application Priority Data
May 2, 2018 (FR) 1853800

(51) Int. Cl. B25J 9/00; A61H 3/00

(52) U.S. Cl. CPC B25J 9/0006; A61H 3/00; A61H 2201/1652; A61H 2201/1645; A61H 2003/007; A61H 2201/1626

(57) ABSTRACT

The present invention relates to a load transfer belt adapted to carry at least one accessory of a passive exoskeleton, the load transfer belt comprising, on the one hand, coupling means of an accessory of a passive exoskeleton and, on the other hand, a backrest equipped with two lateral flanks which extend laterally from a fastening end connected to the backrest towards a free end. According to the invention, each lateral flank comprises a first rigid portion which extends from the fastening end towards the free end.

The present invention belongs to the field of assistance for human effort, especially in the area of assisting handling operations, whether in one-off or repetitive tasks.

In this respect, exoskeletons have been developed to improve the working conditions of a service operator. Exoskeletons have applications in many fields of activity, such as the industrial, mechanical maintenance (automotive, aeronautical, rail, ship, etc.), handling, healthcare, construction, etc. sectors.

The exoskeleton is a mechanical structure worn over the human skeleton to give it physical capacities which it lacks or no longer has.

There are currently two main types of exoskeleton. A first type is the robotic exoskeleton, designed to be installed on both the lower and upper limbs. The robotic exoskeleton makes it possible to significantly increase the strength of the operator wearing it. However, it has the drawback of being heavy and cumbersome, which limits the agility of the operator wearing it, especially when working in a confined environment. Therefore, this type of exoskeleton is unsuitable for a work position where the tasks vary greatly. In addition, the robotic exoskeleton generally has limited autonomy because of the capacity of its batteries.

A second type of exoskeleton concerns passive exoskeletons. Unlike the robotic exoskeleton, the passive exoskeleton or exoskeleton is intended to reduce the effort required from the operator, not to increase the strength of the operator wearing it. Therefore, the passive exoskeleton is in line with an approach that reduces the arduousness of repetitive and/or demanding tasks while preventing the appearance of musculoskeletal disorders (MSDs).

Several types of passive exoskeletons are known that are installed on the lower and/or upper limbs of the operator's body. Most passive exoskeletons aim to support the operator through a flexible mechanical structure worn by the operator. Generally, the passive exoskeleton is lighter than a robotic exoskeleton and comprises elastic return mechanisms consisting of, depending on the case, actuators or springs, and articulated arm systems.

Most existing passive exoskeletons use a belt to fasten the passive exoskeleton to the operator's anatomy. The belt comprises a backrest from which lateral flanks, likely to be secured at their free end, extend on either side. Thus, these lateral flanks are essentially provided with locking means such as a strap and loop system to close the belt.

Other passive skeletons can comprise a belt combined with a harness to fasten the passive exoskeleton to the operator's anatomy. Unfortunately, the harness generally rests, by means of straps, on the operator's shoulders and exerts tension on the actuator muscles of the shoulder joints, such as the deltoids and/or trapezoids. As well as the feeling of discomfort the operator may experience, the tension exerted on the shoulder's actuator muscles coincidentally contributes to limit the shoulder's range of movement, and therefore reduce the operator's agility.

There are also harnesses that rest on the operator's thorax. In the same way, such a configuration is likely to create a feeling of discomfort, especially in female operators, and reduce the range of movements of the torso and shoulders.

In addition, to assist the operator in his tasks the belt comprises a coupling panel on the rear surface of the backrest for receiving one or more accessories, such as a carrier arm, tool mount, wrist support, etc.

Positioned on the operator's back, the coupling panel does not allow the operator to kit up by himself, and requires help from a third party for installing and removing the accessory on this coupling panel. This lack of autonomy can be a problem, for example in the case of a person working on his own.

In addition, the loads are transmitted directly from the accessories to the coupling panel and contribute to increasing the loads that are exerted on the spine and can result in collapsed vertebrae. This is all the more probable when the belt is combined with a harness resting on the upper body, in particular on the shoulders.

In addition, poor positioning of this belt can also be counterproductive and cause musculoskeletal disorders.

It should be noted that the recently-published document WO 2018/069594 describes a load transfer belt whose purpose is to transfer the loads to the bone structure of the pelvis.

To this end, document WO 2018/069594 describes a load transfer belt which comprises a backrest fitted with two flexible lateral flanks that extend on either side of the backrest. Straps extend from the flexible lateral flanks, forming a belt that can be adjusted to the operator's size. In addition, the back portion of the backrest comprises a rigid part and means for coupling to an accessory. The back portion is thus able to support a load transmitted by an accessory such as a mechanical arm.

Although the load transfer belt of document WO 2018/069594 reduces the loads exerted on the spine, only the back portion of the belt has rigid elements. Thus, the back portion carries the accessories and transfers the loads, mainly to the posterior portion of the pelvis. Since the loads are not distributed evenly over the pelvis, this can create an imbalance, notably an anteversion position of the operator's pelvis.

With regard to the drawbacks noted in the prior art, the applicant has developed an ergonomic load transfer belt making it possible to optimize the transfer of loads from the accessories to the pelvic bone structure, in particular to the iliac crests of the pelvis, which distribute the loads over the entire pelvis. In this context, the iliac crests have the advantage of receiving the insertion of powerful muscles, such as the abdominals, which allow the pelvic bone structure to support significant loads.

In this respect, the present invention relates to a load transfer belt adapted to carry at least one accessory of a passive exoskeleton, the load transfer belt comprising, on the one hand, means for coupling an accessory of a passive exoskeleton and, on the other hand, a backrest fitted with two lateral flanks which extend laterally from a fastening end connected to the backrest towards a free end. The load transfer belt is characterized in that each lateral flank comprises at least a first rigid portion which extends from the fastening end towards the free end. Advantageously, the rigid nature of the first portion makes it possible to rest on the pelvic iliac crests of an operator and to optimize the distribution of loads over the pelvic bone structure.

In this way, thanks to the first rigid portion of each lateral flank, the load transfer belt according to the invention makes it possible to transfer the loads experienced by the accessories toward the operator's pelvis. This characteristic plays a role in the operator's comfort and in preventing musculoskeletal disorders, of the spine in particular.

In addition, the load transfer belt of the present invention also makes it possible for the operator to install and remove equipment without help from a third party.

In effect, according to a first characteristic of the invention, the first portion of at least one lateral is fitted with coupling means. Laterally positioned in this way, the coupling means contribute, firstly, to freeing the operator's upper body and enabling him to install equipment without help from a third party, and secondly to directly transfer the loads experienced by the accessories toward the operator's pelvis.

According to a second characteristic of the invention, the lateral flanks comprise means for connecting their free end.

According to a third characteristic of the invention, the coupling means are defined by receiving means designed to form an articulated link with an accessory of a passive exoskeleton.

According to a fourth characteristic of the invention, the coupling means comprise an adjustment system enabling the position of the coupling means to be adjusted along at least one axis.

According to a fifth characteristic of the invention, the backrest comprises a fool-proofing system such that an operator positions the load transfer belt correctly. More specifically, the fool-proofing system comprises, on the one hand, a lumbar curve configured to rest on an operator's lumbar curve and, on the other hand, a thoracic curve configured to rest on an operator's lower thoracic curve.

According to a sixth characteristic of the invention, the load transfer belt comprises a system for the concentric adjustment of each lateral flank such that the operator positions the load transfer belt correctly according to a synchronized translation of each lateral flank. For this purpose, the concentric adjustment system comprises at least one guide in which each lateral flank is engaged by means of at least one pad that is complementary to the guide.

Advantageously, the concentric adjustment system comprises a synchronization mechanism that is connected, on the one hand, to each lateral flank and, on the other hand, to the backrest, thus ensuring a synchronized translation of one lateral flank relative to the other.

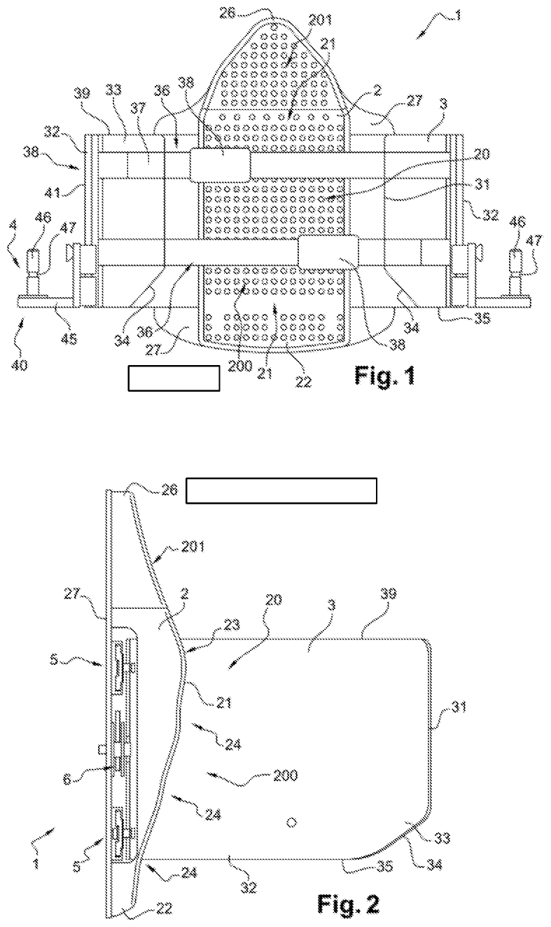

Other advantages and special features will become apparent in the following detailed description of a non-limiting example of realization of the invention that is illustrated by the FIGS. 1 to 9 included in an appendix, in which:

FIG. 1 is a representation of a front view of a load transfer belt according to an example of realization of the invention;

FIG. 2 is a representation of a side view of a backrest of the load transfer belt of FIG. 1;

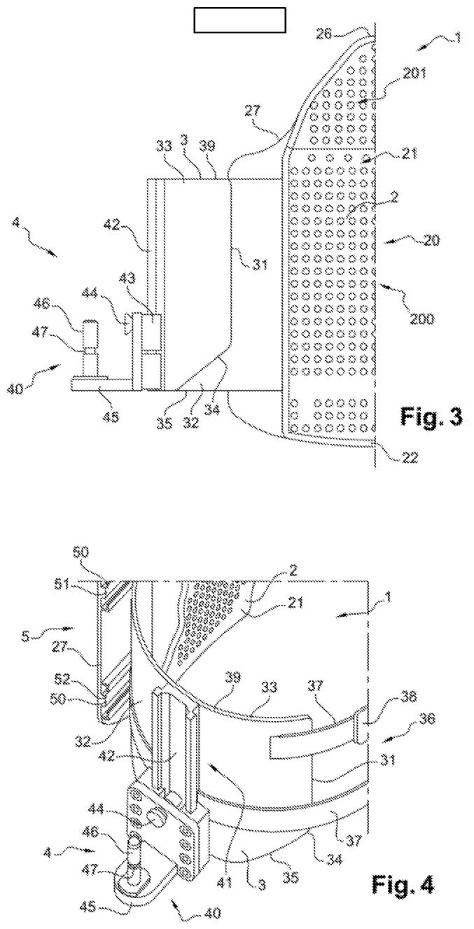

FIG. 3 is a representation of a lateral flank of the load transfer belt of FIG. 1, the lateral flank being fitted with means for coupling an accessory of a passive exoskeleton;

FIG. 4 is a representation in perspective of the coupling means of FIG. 3;

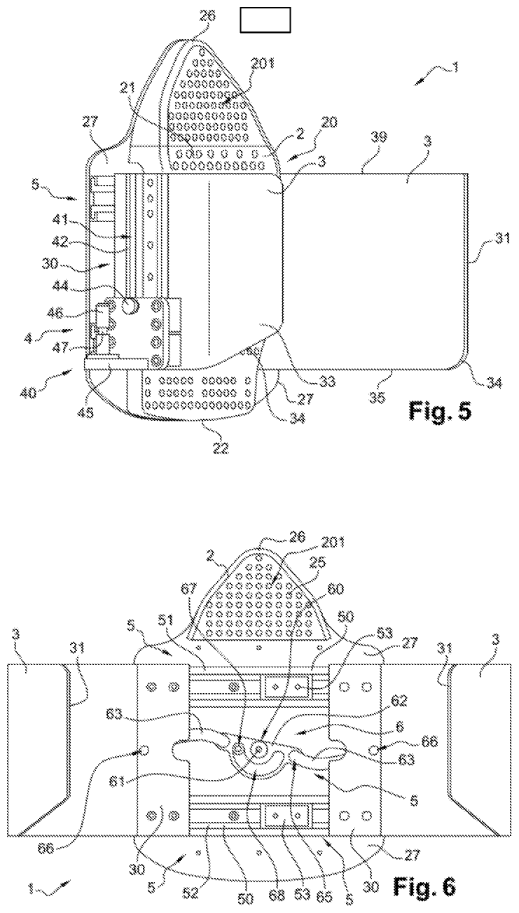

FIG. 5 is a representation in perspective of the load transfer belt of FIG. 1;

FIG. 6 is a representation of a system for the concentric adjustment of each lateral flank, the lateral flanks being deployed;

FIG. 7 is a representation of the concentric adjustment system of FIG. 6, the lateral flanks being retracted;

FIG. 8 is a representation in perspective of a return mechanism forming part of the concentric adjustment system of FIG. 7; and

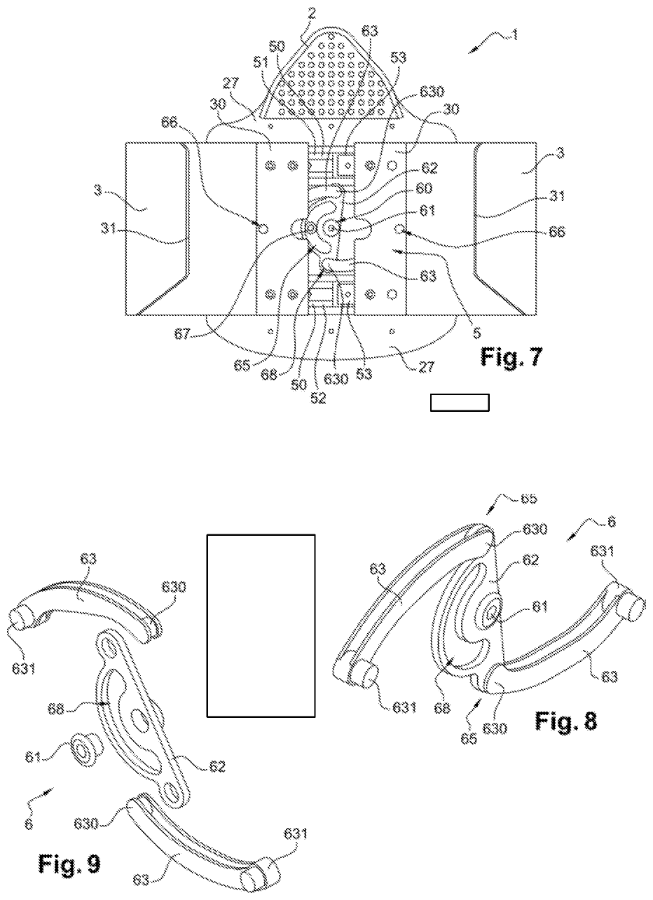

FIG. 9 is an exploded view of the synchronization mechanism of FIG. 8.

The invention illustrated in FIGS. 1 to 9 relates to a load transfer belt 1 adapted to carry at least one accessory of a passive exoskeleton in the context of a one-off or repetitive handling operation.

In the example illustrated in FIGS. 1 to 5, the belt 1 comprises a backrest 2 ensuring an optimal position of the belt 1 regardless of the operator's morphology. To this end, the backrest 2 comprises a fool-proofing system 20 making it possible, in particular, to rest on the operator's lumbar curve.

To this end, and as illustrated in FIG. 2, the fool-proofing system 20 comprises a lumbar curve 200 which is designed to at least partially adopt the shape of an operator's lumbar curve. For this purpose, the backrest 200 comprises a support surface 21 curved so as to rest on the operator's lumbar curve.

The lumbar curve is a characteristic of the human species, and corresponds to vertebrae L1 to L5 located in the lower back. In order to adopt the shape of the lumbar curve, the support surface 21 extends from a bottom end 22 to a curve 23. Preferably, the support surface 21, between the bottom end 22 and the curve 23, has a line possessing three undulations 24 so as to accommodate the spinous process of at least one of vertebrae L1 to L5. Here, the backrest 2 gets thicker going from the bottom end 22 to the curve 23. In addition, to stabilize the backrest 2 the bottom end 22 is configured to rest on the sacral curve of the operator's spine.

Correct positioning of the belt 1 makes it possible to prevent the adoption of a poor work posture, and more specifically a poor pelvic posture, whereas an incorrect adjustment of the belt 1 can lead the operator to adopt a position in anteversion (torso tilted forwards) and/or in retroversion (torso tilted backwards). However, repetitive work in such positions can result in the appearance of musculoskeletal disorders, such as lumbar hyperlordosis.

Still with the aim of preventing musculoskeletal disorders, the backrest 2 comprises a thoracic curve 201 configured to rest on an operator's lower thoracic curve. To this end, the thoracic curve 201 is above the lumbar curve 200. More specifically, the thoracic curve 201 extends from the curve 23 towards an upper end 26 of the backrest 2. The backrest 2 gets thinner going from the curve 23 to the upper end 26 of the backrest 2.

Advantageously, the thoracic curve 201 makes it possible to absorb the torques that are exerted on the belt 1 to the front and tend to tilt the operator in retroversion. Of course, to increase the operator's comfort, the backrest 2 can be covered with a comfort covering, for example a foam type.

In the example illustrated in FIGS. 1 to 7, the belt 1 comprises two lateral flanks 3 designed to surround the operator's hips at least partially. More specifically, each lateral flank 3 extends laterally from a fastening end 30 connected to the backrest 2 towards a free end 31.

Advantageously, each lateral flank 3 comprises, from its fastening end 30 to its free end 31, a first rigid portion 32 prolonged by a second, more flexible, portion 33. In practice, each lateral flank 3 is formed in one piece, the more rigid first portion 32 benefiting from greater thickness than the second portion 33. The second portion 33 has a more flexible nature than the first portion 32 thanks to the reduction in the thickness of the lateral flank 3.

Note that the first portion 32 of each lateral flank 3 is developed to rest on an iliac crest of the operator's pelvis. Thus, the first portion 32 of each lateral flank 3 plays a role in transferring the loads absorbed by the belt 1 towards the operator's pelvis.

Preferably, each lateral flank is made of a composite and/or polymeric material, such as a material based on carbon fibers.

In addition, each lateral flank 3 comprises a bevel 34 at the location of the lower edge 35 of its free end 31. The bevel 34 boosts the operator's mobility by preventing stress being applied on the front portion of the operator's pelvis. In addition, the bevel 34 also prevents the lateral flanks 3 from restraining the mobility of the operator's thighs.

As illustrated in FIG. 1, the lateral flanks 3 comprise means 36 for connecting their free end 31. Typically, the connection means 36 comprise at least one strap 37 cooperating with an adjustment system 38 such as a tightening loop.

As illustrated in FIGS. 1, 3 and 4, at least one lateral flank 3 comprises means 4 for coupling an accessory of a passive exoskeleton. In this example, the first portion 32 of at least one of the lateral flanks 3 is fitted with coupling means 4. Preferably, the first portion 32 of each lateral flank 3 comprises coupling means 4. It is therefore possible for two accessories of a passive exoskeleton, such as arm supports, to be coupled to the belt 1.

Given that the first portion 32 of each lateral flank 3 is configured to rest on an iliac crest of the operator, the position of the coupling means 4 at the location of the first portion 32 makes it possible to avoid putting stress on the spine. The loads are transferred directly from the accessory coupled with the coupling means 4 to the pelvic bone structure of the operator.

In addition, the lateral position of the coupling means 4 improves their accessibility and also boosts the operator's autonomy. In effect, because of this lateral position, the operator is able to install equipment without help from a third party.

In this example, the coupling means 4 are defined by receiving means 40 designed to form an articulated link with an accessory of a passive exoskeleton such as an arm support, a carrier arm, a tool mount, a wrist support, a posture harness, elements of an exoskeleton for an operator's lower limbs, etc.

Advantageously, the coupling means 4 comprise an adjustment system 41 enabling the position of the coupling means 4 to be adjusted. Preferably, the adjustment system 41 adjusts the position of the receiving means 40 along at least one axis. Here, the adjustment system 41 adjusts the position of the receiving means 40 along an axis perpendicular to the direction in which a lateral flank 3 extends.

For this purpose, the adjustment system 41 comprises a rail 42 which extends along an axis perpendicular to the direction in which the lateral flank 3 extends. In particular, the rail 42 extends from the lower edge 35 of the lateral flank 3 to an upper edge 39 of the lateral flank 3.

In this example, the adjustment means 41 have a sliding part 43 engaged on the rail 42. The sliding part 43 cooperates with a clamping element 44 between an activated position and a deactivated position. When the clamping element 44 is in the activated position, it blocks the translation of the sliding part 43 along the rail 42 and enables the receiving means 40 to be kept in a certain position. Conversely, when the clamping element 44 is in the deactivated position, the sliding part 43 is free to slide along the rail 42. In practice, the clamping element 44 can be formed by a screw, a pin cooperating with holes, etc.

This configuration of the adjustment system 41 allows the operator to adjust the height of the position of the receiving means 40, relative to the lateral flank 2, and according to its size.

To form an articulated link with an accessory of a passive exoskeleton, the receiving means 40 comprise a stirrup-shaped part 45 having a free end 46 designed to form a pivoting connection with an accessory.

In this example, the free end 46 extends along an axis parallel to the rail 42. In this example, the free end 46 is formed by a small pillar. The free end 46 can provide a pivoting connection with a socket complementary to the free end 46, the socket being on the accessory.

To ensure an optimum engagement between the free end 46 and a complementary socket, the small pillar can comprise a center groove 47 that extends in a direction transverse to the axis of the free end 46.

As illustrated in FIGS. 2 and 6 to 9, so that every operator can adjust the belt 1 to his morphology, and in particular to the width of his pelvis and/or abdominal zone, the belt 1 comprises a system 5 for the concentric adjustment of the lateral flanks 3.

In particular, to ensure a synchronized translation of one lateral flank 3 relative to the other, the concentric adjustment system 5 comprises a synchronization mechanism 6.

As illustrated in FIGS. 6 to 9, the synchronization mechanism 6 is connected to each lateral flank 3 and to the backrest 2. Thus, the synchronization mechanism 6 forms an axial pivoting connection 60 with a panel 27 that is secured to the rear of the backrest 2. To this end, the synchronization mechanism 6 comprises an axle 61 secured to the panel 27 and a disk 62 mounted rotatably on the axle 61. The cooperation between the disk 62 and the axle 61 forms the axial pivoting connection 60.

Advantageously, the synchronization mechanism 6 comprises two connecting rods 63 having a first end 630 which forms a first pivoting connection 65 with the disk 62. At the same time, a second end 631 of the connecting rod 63 forms a second pivoting connection 66 with a fastening end 30 of the lateral flank 3. Here, the first pivoting connection 65 of each connecting rod 63 is mounted radially opposite on the disk 62.

As illustrated in FIGS. 6 to 9, the connecting rods 63 are arched to reduce the size of the synchronization mechanism 6, especially when said mechanism is in the retracted position (illustrated in FIG. 7).

Conversely, when the operator adjusts the belt to his size, the synchronization mechanism 6 is in the deployed position (illustrated in FIG. 6).

In addition, with the aim of limiting the translation path of each lateral flank 3, the synchronization mechanism 6 comprises a stop 67 cooperating with a radial groove 68 formed on the disk 62.

According to an example of realization of the invention, not illustrated, the synchronization mechanism 6 can be formed by a rack connected, on the one hand, to each lateral flank 3 and, on the other hand, to the panel 27.

In addition, the concentric adjustment system 5 comprises at least one guide 50 in which each lateral flank 3 is engaged. Preferably, the concentric adjustment system 5 comprises two guides 50 in which the two lateral flanks 3 are engaged. Here, each guide 50 is formed by a channel 51 formed in the panel 27.

The two guides 50 are parallel to each other and extend on either side of the synchronization mechanism 6 along a plane defined by the panel 27. A first guide 51 is positioned above the synchronization mechanism 6 while a second guide 52 is positioned lower relative to the synchronization mechanism 6.

The fastening end 30 of each lateral flank 3 is engaged on a guide 50, 51, 52 by means of at least one pad 53 that is complementary to the guide 50, 51, 52 it cooperates with. Advantageously, each guide 50, 51, 52 makes it possible to ensure a regular translation path of each lateral flank 3 when the operator adjusts the belt 1 to his size.

Notably, the concentric adjustment system 5 encourages an optimal position and adjustment of the belt 1 by forcing the operator to move the two lateral flanks 3 synchronously and along the same axis.

Consequently, both the backrest 2 and the concentric adjustment system 5 play a role in the operator's comfort by optimizing the position and adjustment of the belt 1 while freeing the operator's upper body from any constraint.

In addition, optimizing the position and adjustment of the belt 1 thus results in a position of the receiving means 40 that repeats the insertion axis of the arm on the operator's shoulder. This configuration makes it possible to create an articulated link with at least one accessory such as an arm support or an articulated arm having a similar range of movement to a human arm.

According to another example of realization of the invention, the belt 1 can comprise additional coupling means to carry other accessories of a passive exoskeleton. For example, the belt 1 can comprise additional coupling means secured to the panel 27.

1. A load transfer belt adapted to carry at least one accessory of a passive exoskeleton, the load transfer belt comprising, on the one hand, means for coupling an accessory of a passive exoskeleton and, on the other hand, a backrest fitted with two lateral flanks which extend laterally from a fastening end connected to the backrest towards a free end, wherein each lateral flank comprises at least a first rigid portion which extends from the fastening end towards the free end.

2. A load transfer belt according to claim 1, wherein the first portion of at least one lateral flank is fitted with coupling means.

3. A load transfer belt according to claim 1, wherein the lateral flanks comprise means for connecting their free end.

4. A load transfer belt according to claim 1, wherein the coupling means are defined by receiving means designed to form an articulated link with an accessory of a passive exoskeleton.

5. A load transfer belt according to claim 1, wherein the coupling means comprise an adjustment system enabling the position of the coupling means to be adjusted according to an axis.

6. (canceled)

7. (canceled)

8. (canceled)

9. (canceled)

10. (canceled)

11. A load transfer belt according to claim 5, wherein the adjustment system comprises a sliding part engaged on a rail, the sliding part cooperating with a clamping element 44 between an activated position blocking the translation of the sliding part in the rail and a deactivated position enabling said translation.

12. A load transfer belt according to claim 1, wherein the backrest comprises a fool-proofing system such that an operator positions the load transfer belt correctly.

13. A load transfer belt according to claim 12, wherein the fool-proofing system comprises, on the one hand, a lumbar curve configured to rest on an operator's lumbar curve and, on the other hand, a thoracic curve configured to rest on an operator's lower thoracic curve.

14. A load transfer belt according to claim 1, comprising a synchronized adjustment system for each side flank configured to translate each side flank relative to the backrest simultaneously.

15. A load transfer belt according to claim 14 wherein the synchronized adjustment system comprises at least one translation guide in which each side flank is engaged through at least one slide complementary to the guide.

16. A load transfer belt according to claim 14, wherein the synchronized adjustment system comprises a synchronization mechanism which is connected, on the one hand, to each lateral flank and, on the other hand, to the backrest by means of pivot connections.

17. A load transfer belt according to claim 16, wherein the synchronization mechanism comprises :
a disc pivotally connected to the backrest, and
for each side flank, a connecting rod, pivotally connected to the disc on the one hand, and said side flank on the other hand.

18. A load transfer belt according to claim 17, wherein the connecting rods are arranged symmetrically with respect to the axis of the pivot connection between the disc and the backrest.

19. A load transfer belt according to claim 17, wherein at least one connecting rod is arched.

20. A load transfer belt according to claim 14, comprising a stop for limiting the translation of each side flank.

21. A load transfer belt according to claim 16, comprising a rack connected to each side flank and activated by a pinion.

22. A load transfer belt according to claim 1, wherein the backrest is covered with a comfort covering.

23. A load transfer belt according to claim 1, wherein each lateral flank comprises two portions of different rigidity.

24. A load transfer belt according to claim 23, wherein from the fastening end to the free end, a first rigid portion prolonged by a second, more flexible, portion obtained by a reduction in the thickness of the lateral flank.
